(19) United States
(12) Patent Application Publication
(10) Pub. No.: US 2002/0005598 A1
(43) Pub. Date: Jan. 17, 2002

(54) Method of controlling the screw of injection molding machine

(76) Inventors: Akira Kanda, Numazu-shi (JP); Takashi Yamazaki, Mishima-shi (JP); Jun Koike, Shizuoka-ken (JP); Yukio Iimura, Shizuoka-ken (JP); Haruyuki Matsubayashi, Numazu-shi (JP); Yutaka Yamaguchi, Shizuoka-ken (JP)

Correspondence Address: Pillsbury Winthrop LLP, Ninth Floor, East Tower, 1100 New York Avenue, N.W., Washington, DC, 20005-3918, US

(21) Appl. No.: 09/899,221

(22) Filed: Jul. 6, 2001

(30) Foreign Application Priority Data
Jul. 17, 2000 (JP) 2000-216133

(51) Int. Cl. B29C 45/76

(52) U.S. Cl. 264/40.1; 264/40.5

(57) ABSTRACT

The object of this invention is to suppress the generation of surge pressure at the moment of shifting from the filling step to the holding step, thereby ensuring the stabilization in quality of molded products. In the filling step, the screw is advanced from the charging finish point at a predetermined speed while renewing the positioning command at time intervals. Simultaneously, the position of screw is monitored to see if it has reached the holding initiating point. When the screw has reached the holding initiating point, the holding step is initiated, and the next positioning command is switched from the present positioning command into one wherein a predetermined value of correction is added to the present positioning command, thereby decelerating (or moving back) the screw. After shifted to the holding step, the position of screw is controlled while renewing the positioning command at time intervals.

### CROSS-REFERENCE TO RELATED APPLICATIONS

This application is based upon and claims the benefit of priority from the prior Japanese Patent Application No. 2000-216133, filed Jul. 17, 2000, the entire contents of which are incorporated herein by reference.

### BACKGROUND OF THE INVENTION

This invention relates to a method of controlling the screw of injection molding machine. In particular, this invention relates to a method of controlling the screw of injection molding machine so as to suppress the generation of surge pressure at the moment of shifting from the filling step to the holding step on the occasion of injecting a molten resin into a mold by advancing the screw provided in the heating barrel.

In the operation of injection molding machine, a heating barrel provided therein with a screw is generally employed. A raw resin is introduced into the heating barrel with the rotation of the screw, the raw resin thus introduced being melted inside the heating barrel. This molten resin is then injected into the cavity of mold through the advancement of the screw. The former process is called “a charging step”. The latter process is divided into two stages, i.e. “a filling step” wherein the screw is advanced at a predetermined speed within the heating barrel, and “a holding step” wherein the position of the screw is controlled so as to maintain the pressure of the resin in the mold at a predetermined level after the screw has been advanced up to a preset position (which is called “holding initiating point”).

The conventional method of controlling the screw however is accompanied with the following problems. When it is required to perform the filling of resin at a high speed, it is impossible according to the conventional controlling method to sufficiently suppress the inertia force in the advancing direction of the screw. As a result, a large magnitude of surge pressure is generated at the moment of shifting from the filling step to the holding step. If the surge pressure is generated in this manner, the pressure of resin filled in the mold becomes unstable after the filling step is shifted to the holding step, thus resulting in the fluctuation in quality of molded product and also badly affecting the yield thereof. Furthermore, depending on the magnitude of the surge pressure, the mold may be damaged.

### BRIEF SUMMARY OF THE INVENTION

This invention has been accomplished in view of overcoming these problems accompanied with the conventional method of controlling the screw in the injection molding machine. Therefore, an object of this invention is to provide a method of controlling the screw of injection molding machine, which makes it possible to suppress the generation of surge pressure that may occur at the moment of shifting from the filling step to the holding step, thereby ensuring the stabilization in quality of molded products even if the filling of resin is performed at a high speed, Namely, this invention provides a method of controlling the screw of injection molding machine, the method comprising:

a charging step wherein a predetermined quantity of resin is introduced into and melted in a heating barrel provided therein with the screw;

a filling step wherein the screw is advanced in the heating barrel with a position of the screw being controlled according to a command, thereby filling a mold with the resin; and

a holding step wherein a pressure of the resin in the mold is maintained at a predetermined value by controlling the position of the screw according to a command;

wherein a positioning command in feedback control related to the position of the screw, is given at the moment of shifting from the filling step to the holding step, in such a way that the screw is to be placed at a position which is located backward by a preset correction value from the commanded position immediately before the positioning command.

According to the method of controlling the screw of injection molding machine, in the filling step the position of the screw, the time elapsed after the initiation of filling step, or the pressure of the resin is monitored, and the shifting from the filling step to the holding step is executed when the monitored value reaches a predetermined value.

The screw is stopped moving in the holding step, when it is admitted that the time elapsed after the initiation of holding step has reached a predetermined value, or the screw has reached a forward limit.

The monitoring of the pressure of resin in the filling step or holding step can be performed as follows.

(a) A pressure sensor is disposed inside the mold so as to enable the pressure of resin in the mold to be directly detected;

(b) A pressure sensor is disposed inside the heating barrel (or inside the nozzle attached to the distal end thereof) so as to enable the pressure of resin in the vicinity of the distal end of the barrel to be detected;

(c) The back pressure of the screw is detected with a load cell attached to the rear end of the screw, the value thus detected being assumed as the pressure of resin; and

(d) The back pressure of the screw is measured on the basis of the driving torque (or driving current) of the servo-motor which is employed for driving the screw.

When the positioning command on the feedback control loop is switched as described above at the moment of shifting from the filling step to the holding step, the screw is decelerated or, under some circumstances, moved backward. The specific state of screw on this occasion varies depending on the advancing speed of screw, on the deviation between the command input and controlled variable in the feedback loop, or on the way of presetting the parameters of the feedback loop (P, I, D).

According to the method of this invention for controlling the screw of injection molding machine, since the screw can be decelerated (under some circumstances, moved backward) at the moment of shifting from the filling step to the holding step, the generation of surge pressure can be suppressed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram illustrating a motorized injection molding machine to which the screw-controlling method according to this invention is applied;

FIG. 2 is a flow chart illustrating the screw-controlling method according to this invention;

FIG. 3 is a graph illustrating the relationship between the position of screw and the speed of screw, and the relationship between the position of screw and the injection pressure, in the case where the controlling method according to this invention was adopted; and

FIG. 4 is a graph illustrating the relationship between the position of screw and the speed of screw, and the relationship between the position of screw and the injection pressure, in the case where the controlling method according to the prior art was adopted.

### DETAILED DESCRIPTION OF THE INVENTION

The method of controlling the screw of injection molding machine according to this invention will be explained with reference to drawings. In this embodiment, the shifting point to the holding step is determined by monitoring the position of the screw.

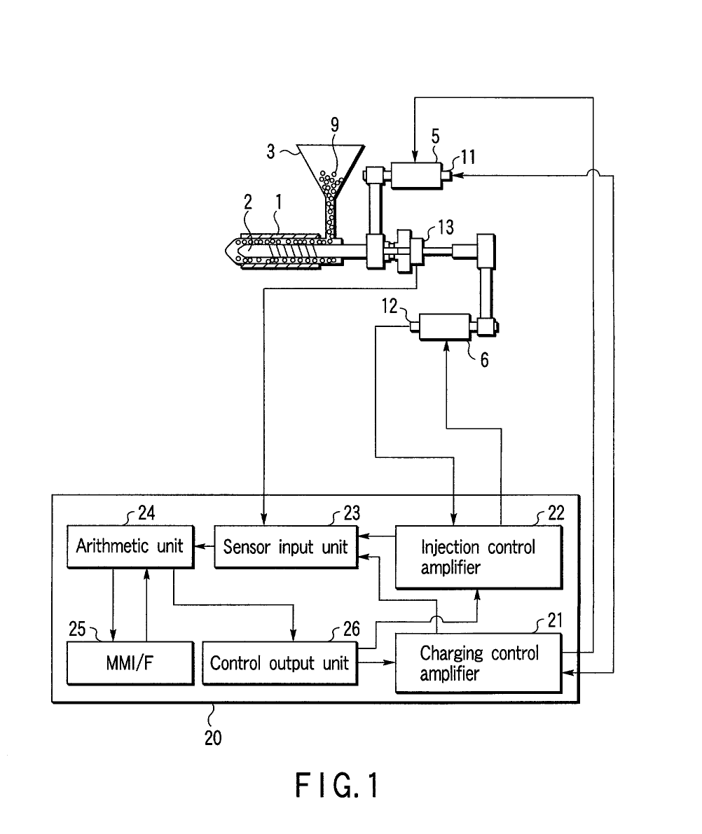

FIG. 1 shows a structure comprising an apparatus and a control system thereof, illustrating one embodiment where the control method of this invention is applied to a motorized injection molding machine. In the drawing, a reference number 1 denotes a heating barrel, 2 a screw, 3 a hopper, 5 a motor for charging, 6 a motor for injection, and 20 a control system.

The heating barrel 1 is provided therein with a screw 2. The heating barrel 1 is connected, through one side near the rear end thereof (on the right side in FIG. 1), with the hopper 3. The distal end (on the left side in FIG. 1) of the heating barrel 1 is adapted to be connected with the rear side of mold (not shown). A molding material 9 consisting of granular resin is introduced into the heating barrel 1 from the hopper 3 so as to be heated, melted and kneaded in the heating barrel 1. After being accumulated once at a distal end portion of the heating barrel 1, the kneaded resin is injected in the mold.

The rear end portion of the screw 2 is connected with the motor for charging 5 and with the motor for injection 6. The motor for charging 5 functions to rotate the screw 2 in the heating barrel 1 during the charging step. As a result, the resin 9 is introduced from the hopper 3 into the heating barrel 1. The resin 9 thus introduced is transferred, while being heated, melted and kneaded, to a front portion of the screw 2 so as to be accumulated at the distal end of the heating barrel 1. When the resin is accumulated in this manner, the screw 2 is forced to move backward due to the pressure of the accumulated resin. As a result, a quantity of the molten resin, which approximately corresponds to the distance of backward movement of the screw 2, is accumulated at the distal end portion of the heating barrel 1. The motor for injection 6 functions to move the screw 2 in the forward direction in the heating barrel 1 during the injection step, thereby transferring the molten resin into the cavity of the mold.

To the shaft of the motor for charging 5, there is attached a screw revolution detector 11 which is designed to detect the number of revolution of the screw 2. To the shaft of the motor for injection 6, there is attached a screw position detector 12 which is designed to detect the position of the screw 2 in the axial direction thereof on the basis of the rotational angle of the motor. To the rear end portion of the screw 2, there is attached a back pressure detector 13. This back pressure detector 13 is designed to detect a pressure imposed by the screw 2 on the molding material 9 (molten resin) that has been accumulated at the distal end portion of the heating barrel 1, on the basis of the magnitude of counterforce exerted on the rear end of the screw 2.

As shown in FIG. 1, the control system 20 of this motorized injection molding machine is constituted by a charging control amplifier 21, an injection control amplifier 22, a sensor input unit 23, an arithmetic unit 24, an MMI/F (man-machine interface) 25 and a control output unit 26.

The charging control amplifier 21 is designed to collect the data on the number of revolution of the screw 2 detected by the screw revolution detector 11, thereby to control the operation of the motor for charging 5 on the basis of the collected data, and designed to transmit the data on the current being supplied to the motor for charging 5 to the sensor input unit 23. The injection control amplifier 22 is designed to control the operation of the motor for injection 6, and to transmit the data on the position in the axial direction of the screw 2 detected by the screw position detector 12 to the sensor input unit 23. This sensor input unit 23 is designed to transmit various data to the arithmetic unit 24, said various data including the data on the injection pressure of the screw 2 detected the back pressure detector 13, the data on the current supplied to the motor for charging 5 that has been transmitted from the charging control amplifier 21, and the data on the position in the axial direction of the screw 2 that has been transmitted from the injection control amplifier 22.

The arithmetic unit 24 is designed to determine the driving conditions of the screw 2 on the basis of the instruction that has been input via the man-machine interface 25 by the operator, and to deliver a command to the control output unit 26. This control output unit 26 is designed to transmit control signals to each of the charging control amplifier 21 and the injection control amplifier 22 to thereby control the operation of the motor for charging 5 and of the motor for injection 6.

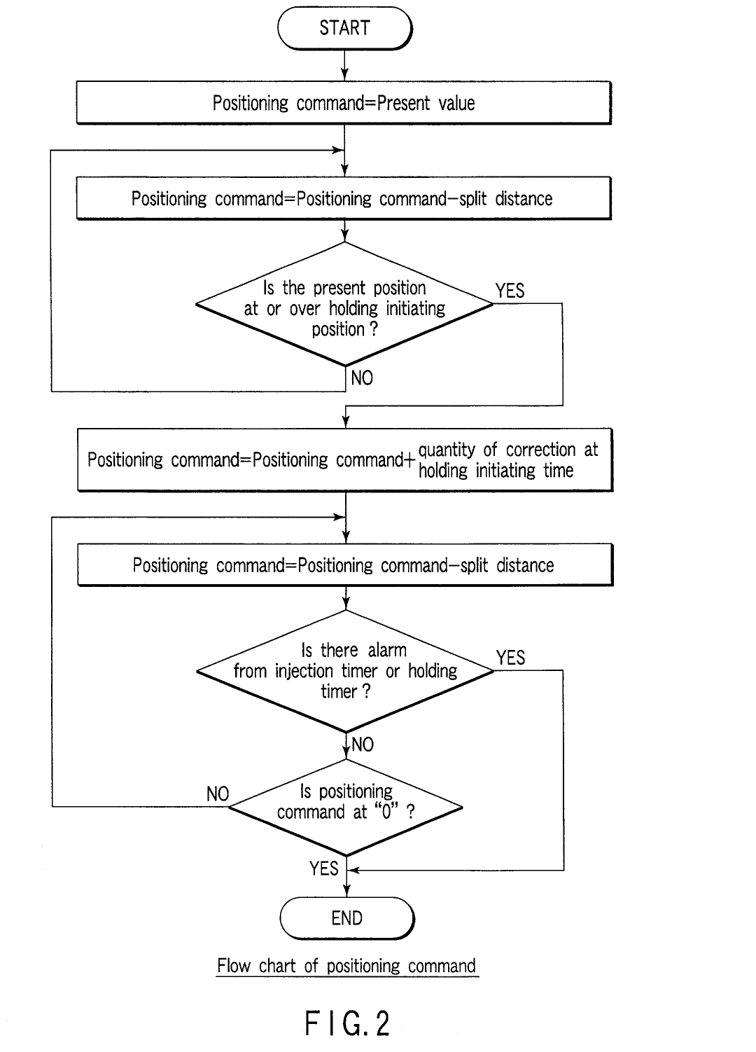

Next, the method of controlling the screw 2 in the process of injecting a resin into the cavity of mold will be explained with reference to the flow chart shown in FIG. 2.

By the way, the “position” set forth in this flow chart means the position of the screw (the screw 2 in FIG. 1) in the heating barrel (the barrel 1 in FIG. 1), wherein the forward limit of the screw (charging initiating point) is defined as being 0 mm, and the backward direction therefrom is represented by plus (+). The charging of molding material (molding material 9 in FIG. 1) is initiated from where the screw is placed at the previous injection finish position (forward limit). As explained above, the screw moves backward gradually while transferring the molding material to the front of the screw. When a predetermined quantity of molding material (i.e. molten resin) is accumulated at the forward portion of the heating barrel, the backward movement of the screw is stopped. This stop position is called “charging finish point”. In this embodiment, the charging finish point is located at a position of 100 mm. Then, the filling step is initiated, wherein the screw is advanced to thereby injecting the molten resin into the cavity of mold.

By the term “positioning command”, it is intended to mean a target position of the screw on the feedback loop in the filling step or in the holding step.

By the term “split distance” (ΔP), it is intended to mean a product of the instructed moving speed (V) of screw that can be determined from the relationship between the preset speed of screw and the pressure thereof (for example, the pressure to be detected by the back pressure detector 13) and the time intervals (Δt) for renewing the positioning command to the screw on the feedback loop in the filling step or in the holding step.

In this embodiment, these parameters are as follows.

V=10 [mm/sec]

Δt=1 [msec]

ΔP=V·Δt=0.01 [mm]

In the flow chart, the symbol “=” means that the positioning command is renewed every moment of the aforementioned time intervals (Δt). Namely, it means that the value on the left side of “=” will be successively replaced by the value on the right side of “=”.

As shown in this flow chart, at the moment of initiating the filling step, the present position (that is, the charging finish point) of the screw is set in the positioning command. After the initiation of the filling step, the screw is advanced at a preset speed for the filling step while renewing the positioning command at aforementioned time intervals (Δt). On this occasion, the position of the screw is monitored to thereby perform the feedback control of the motor for injection (motor for injection 6 in FIG. 1) driving the screw. Simultaneously, the monitoring is also performed with respect to whether or not the screw has reached the holding initiating point (the position at which the filling step is shifted to the holding step). In this embodiment, the holding initiating point is located at a position of 4 mm.

When the screw has reached the holding initiating point, the next positioning command is switched from the present positioning command into one wherein a predetermined value of correction (“correction at holding step initiating time” in FIG. 2; 1 mm in this embodiment) is added to the present positioning command. Namely, the next positioning command is set at a position which is located backward from the present positioning command. As a result, the screw is decelerated or, under some circumstances, moved backward. Thereafter, the process is shifted from the filling step to the holding step.

After being shifted to the holding step, the screw is again advanced at a preset speed for the holding step while renewing the positioning command at aforementioned time intervals (Δt). On this occasion also, the position of the screw is monitored to thereby perform the feedback control of the motor for injection. Simultaneously, the monitoring is also performed with respect to whether or not the time elapsed from the initiation of the filling step or form the holding step has reached a preset value, for example, 60 seconds or 20 seconds, (whether or not an alarm has been given by the timer in FIG. 2), as well as with respect to whether or not the screw has reached the forward limit.

When the aforementioned time has reached the prescribed value, or when the screw has reached the forward limit, the screw is stopped moving to thereby finish the holding step.

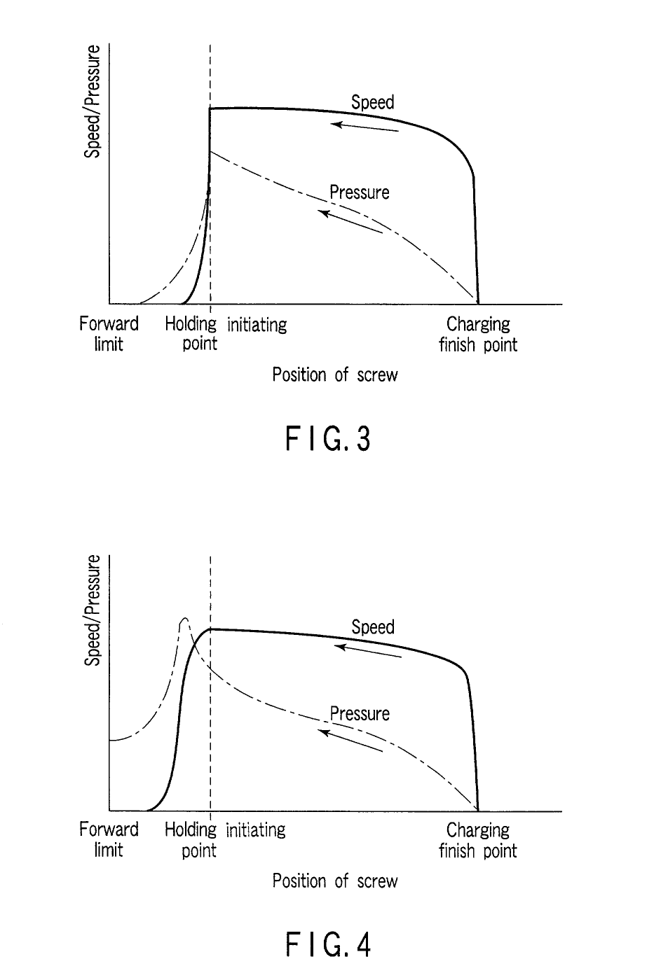

FIG. 3 shows one example of the relationship between the position of screw and the speed of screw, and the relationship between the position of screw and the injection pressure, in the case where the controlling method of this invention was adopted. According to the controlling method of this invention, since the speed of screw was decelerated when the screw had reached the holding initiating point, it was possible to substantially prevent the generation of surge pressure.

FIG. 4 shows one example of the relationship between the position of screw and the speed of screw, and the relationship between the position of screw and the injection pressure, in the case where the controlling method of the prior art was adopted. According to this conventional controlling method, since the deceleration of screw was retarded, a large magnitude of surge pressure was generated.

According to the controlling method of this invention in the operation of an injection molding machine, since the screw-positioning command is temporarily given, at the moment when the screw has reached the holding initiating point in the filling step, in such a manner that the screw is to be placed at a position which is located backward by a preset correction value, the screw is enabled to be decelerated or moved backward. Accordingly, the generation of surge pressure can be suppressed. As a result, it is now possible to prevent the generation of the phenomenon that the pressure of resin in the mold is instabilized after the molding process is shifted to the holding step. Therefore, it is possible according to this invention to stabilize the quality of the injection mold product and to improve the yield thereof. Moreover, it is also possible to prevent the mold from being damaged in the molding operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of controlling the screw of injection molding machine, said method comprising:
a charging step wherein a predetermined quantity of resin is introduced into and melted in a heating barrel provided therein with the screw;
a filling step wherein the screw is advanced in the heating barrel with a position of the screw being controlled according to a command, thereby filling a mold with the resin; and
a holding step wherein a pressure of the resin in the mold is maintained at a predetermined value by controlling the position of the screw according to a command;
wherein a positioning command in feedback control related to the position of the screw, is given at the moment of shifting from said filling step to said holding step, in such a way that the screw is to be placed at a position which is located backward by a preset correction value from the commanded position immediately before said positioning command.

2. The method according to claim 1, wherein in said filling step the position of the screw, the time elapsed after the initiation of filling step, or the pressure of the resin is monitored, and said shifting from said filling step to said holding step is executed when the monitored value reaches a predetermined value.

3. The method according to claim 1, wherein the screw is stopped moving in the holding step when it is admitted that the time elapsed after the initiation of holding step has reached a predetermined value, or the screw has reached a forward limit.
